(19) United States
(12) Patent Application Publication
(10) Pub. No.: US 2026/0267082 A1
(43) Pub. Date: Sep. 10, 2026

(54) PINCER APPARATUS THAT COUPLES AND SECURES GANGED FERRULE CONNECTORS

(71) Applicant: Leviton Manufacturing Co., Inc., Melville, NY (US)

(72) Inventor: Amelia Ann Brown, Lake Forest Park, WA (US)

(21) Appl. No.: 19/158,280

(22) PCT Filed: Jul. 11, 2025
(86) PCT No.: PCT/US2025/037323

§ 371 Date: Aug. 20, 2025

Related U.S. Application Data
(60) Provisional application No. 63/673,228, filed on Jul. 19, 2024.

(51) Int. Cl. G02B 6/38; G02B 6/40

(52) U.S. Cl. CPC G02B 6/389; G02B 6/381; G02B 6/406

(57) ABSTRACT

The described technology facilitates improved connecting or mating for ganged connectors such as ganged fiber optic connectors. For example, a ganged connector can be fitted with a pincer apparatus that can be coupled to a fulcrum element that is exposed at opposing lateral sides of the ganged connector. Lever arms can be attached to the fulcrum to provide mechanical advantage for the applied force. The lever arms can be angled such that the applied force (e.g., a squeezing force) can be multiplied and translated to a connection force that is applied in an axial direction that can be perpendicular to the direction of the squeezing force.

### RELATED APPLICATIONS

This application claims priority to U.S. Provisional Patent Application No. 63/673,288, filed on Jul. 19, 2025, and entitled “PINCER APPARATUS THAT COUPLES AND SECURES GANGED FERRULE CONNECTORS, the entirety of which priority application is incorporated by reference herein.

### TECHNICAL FIELD

The disclosed subject matter relates generally to ganged data cabling, and, in particular, to ganged fiber optic or copper cable connectors.

### BACKGROUND

Arranging multiple individual connection interfaces into a single housing is referred to herein as ganging. Hence, coupling a ganged connector (e.g., male type) to a corresponding ganged connector (e.g., female type) can be simpler, more efficient, and provide greater density metrics for the cabling arrangement. As a result, ganged connectors are widespread in the industry today such as in data center environments or the like.

### SUMMARY

The following presents a simplified summary of the disclosed subject matter in order to provide a basic understanding of some aspects of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

Various embodiments described herein provide a connector apparatus comprising a housing. The housing can comprise a group of connection interfaces situated on an interface side of the connector apparatus that can be opposite, relative to an axial direction, to a conduit side of the connector apparatus. First members of the group of connection interfaces can be respectively configured to couple to a respective second member of a corresponding group of connection interfaces of a corresponding connector apparatus.

The connector apparatus can further comprise a fulcrum element (e.g., a rod or axel) that extends in a lateral direction through the housing and is exposed at opposing lateral sides of the housing. The connector apparatus can further comprise a first lever arm that is coupled to a first portion of the fulcrum element that is exposed at a first side of the housing, and a second lever arm that is coupled to a second portion of the fulcrum element that is exposed at a second side of the housing.

Either or both of the lever arms can comprise a hook section and a lever section. The hook section can extend from the fulcrum element toward the interface side at a first angle relative to the axial direction and can comprise a latch element configured to be secured in a recess of the corresponding connector apparatus. The lever section can extend from the fulcrum element toward the conduit side at a second angle relative to the axial direction. The second angle can have the same or a different magnitude than the first angle.

Hence, in response to a squeezing force applied to the lever portions of the two level arms, a tightening or connecting force is applied by the hook section in the axial direction that can secure the connector apparatus to the corresponding connector apparatus. The squeezing force can comprise a first force applied to the first lever arm in a first direction (e.g., along a direction substantially perpendicular to the axial direction), and a second force applied to the second lever arm in a second direction that is substantially opposite the first direction.

### BRIEF DESCRIPTION OF THE DRAWINGS

Numerous aspects, embodiments, objects, and advantages of the present embodiments will be apparent upon consideration of the following detailed description, taken in conjunction with the accompanying drawings, in which like reference characters refer to like parts throughout, and in which:

FIG. 1 shows an example orthogonal top-down view of an example ganged connector apparatus in accordance with certain embodiments of this disclosure;

FIG. 2 depicts an example orthogonal interface-side perspective of the example GCA in accordance with certain embodiments of this disclosure;

FIG. 3 depicts an example isometric view of an example pincer apparatus coupled to example combined housings for ganged connectors in accordance with certain embodiments of this disclosure;

FIG. 4 depicts a first example isometric view of an example GCA and the pincer apparatus in an example first stage of coupling with a corresponding GCA in accordance with certain embodiments of this disclosure;

FIG. 5 depicts a second example isometric view of the example GCA and the pincer apparatus in the example first stage of coupling with a corresponding GCA in accordance with certain embodiments of this disclosure;

FIG. 6 depicts an example isometric view illustrating an example GCA and the pincer apparatus in an example second stage of coupling with a corresponding GCA in accordance with certain embodiments of this disclosure;

FIG. 7 illustrates an example isometric view illustrating an example GCA and the pincer apparatus in an example third stage of coupling with a corresponding GCA in which a locking mechanism, e.g., a lock, engages in accordance with certain embodiments of this disclosure;

FIG. 8 illustrates an example isometric view illustrating the locking element with respect to two different states of the lever arm in accordance with certain embodiments of this disclosure;

### DETAILED DESCRIPTION

### Overview

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that the disclosed subject matter may be practiced without these specific details. In other instances, well-known structures and devices are shown in block diagram form in order to facilitate describing the disclosed subject matter.

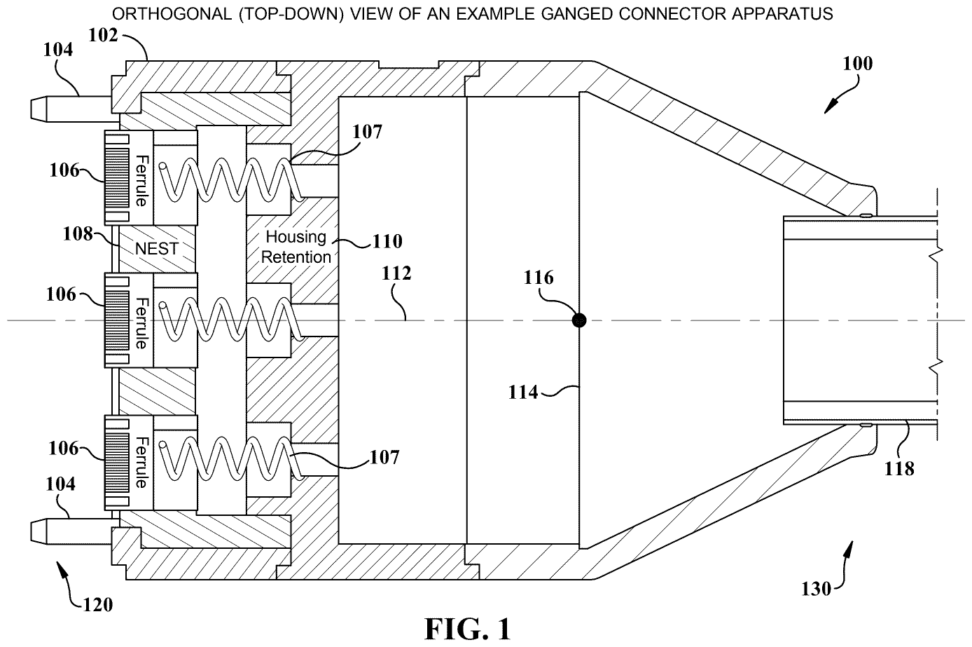

To provide additional context, consider FIG. 1. FIG. 1 shows an example orthogonal top-down view of an example ganged connector apparatus 100 in accordance with certain embodiments of this disclosure.

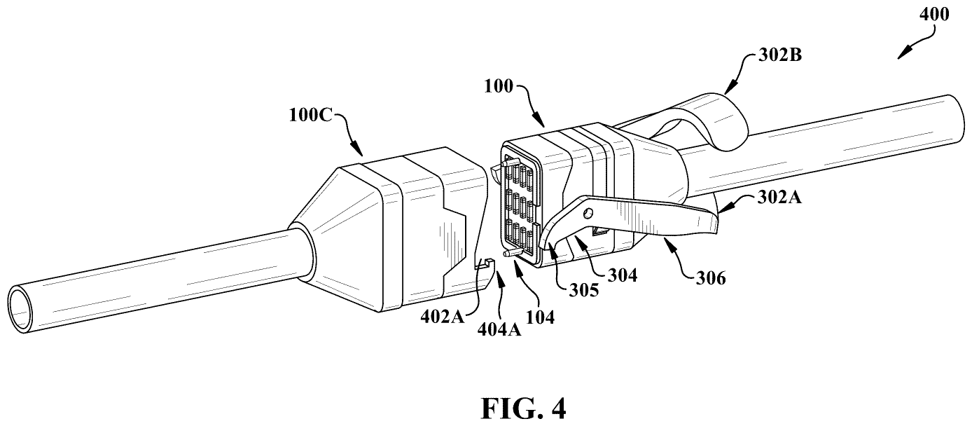

For example, ganged connector apparatus (GCA) 100 comprises housing 102 and alignment guides 104 that are configured to align GCA 100 to a corresponding ganged connector apparatus (e.g., GCA 100C of FIG. 4). In this example, GCA 100 is a male type connector and corresponding GCA 100C is a female type connector, which is used as a representative embodiments, but it is understood that the disclosed techniques can apply independently of the type (e.g., male versus female, . . . ) of connector.

GCA 100 can further comprise a group of connection interfaces 106 that are situated on an interface side 120 of GCA 100. As a representative example, connection interfaces 106 can be fiber optic ferrules that are configured for or compliant with any suitable connector type or form factor, including, for example, a miniature multi-channel (MMC) connector, a multi-fiber push on (MPO) connector, a multi-fiber termination push-on (MTP) connector, or another suitable type of connection interface.

As illustrated, connection interfaces 106 can be situated in a nest 108. Next 108 can be a free-floating material used to gang the individual ferrules and/or connection interfaces 106. Both nest 108 and connection interfaces 106 can be spring loaded, via spring 107, and retained by a housing retention 110 portion of housing 102. Hence, both nest 108 and connection interfaces 106 (e.g., the individual ferrules) can move slightly to achieve proper alignment during a coupling procedure to the corresponding elements of corresponding GCA 100C.

As will be subsequently referenced, FIG. 1 further depicts axial direction 112. Axial direction 112 is intended to represent an axis or direction used herein for reference or other purposes. For example, the interface side 120 is opposite to conduit side 130 relative to an axis or line that is substantially parallel to axial direction 112. Conduit side 130 can expose a cable or conduit associated with GCA 100 (or corresponding GCA 100C).

As will also be discussed further herein, lateral directions 114 and/or 116 can be referenced, both of which can be substantially perpendicular to axial direction 112. Lateral direction 116 can be perpendicular to both axial direction 112 and lateral direction 114, thus can be thought of as extending into or out of the page.

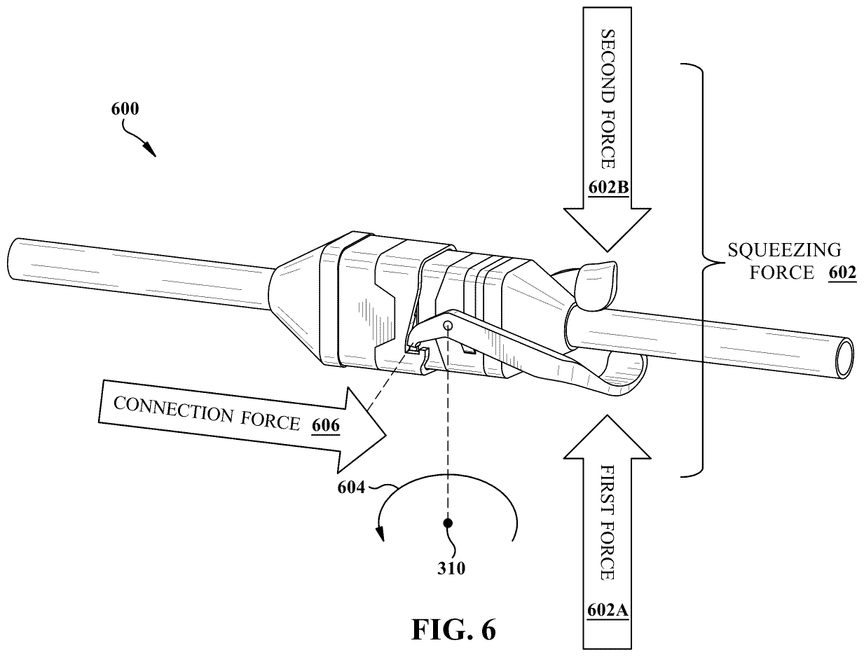

With the foregoing in mind, it can be understood that coupling GCA 100 to corresponding GCA 100C relies on application of a force (e.g., connection force 606 of FIG. 6) in a direction substantially parallel to axial direction 112.

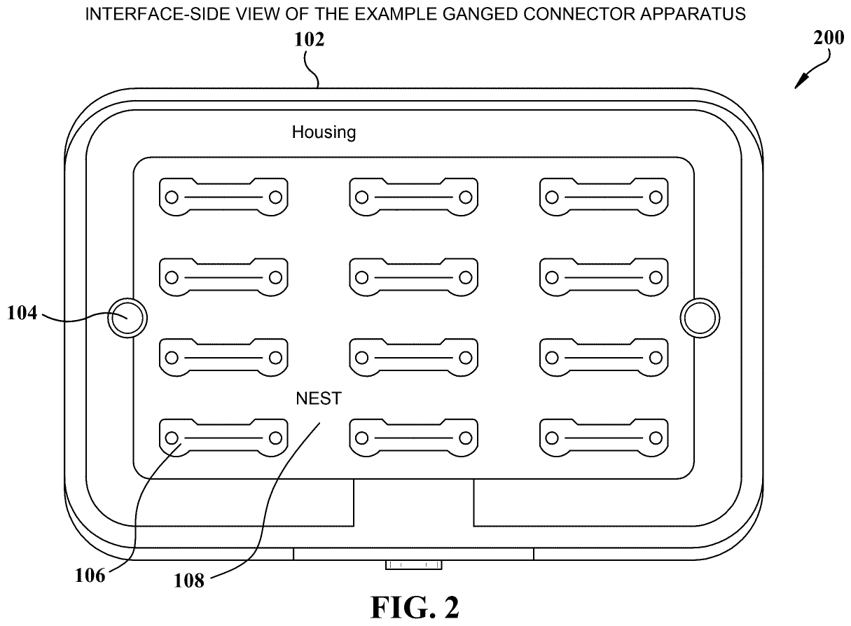

While still referring to FIG. 1, but turning now as well to FIG. 2, FIG. 2 depicts an example orthogonal interface side 120 view of the example GCA 100 in accordance with certain embodiments of this disclosure. Here a front-facing perspective is presented of housing 102, alignment guides 104, connection interfaces 106 and nest 108.

In this example, twelve individual connection interfaces 106 are illustrated, but it is appreciated that GCA 100 can comprise any suitable number of connection interfaces 106, which can be more or fewer than twelve. In order to properly connect GCA 100 to corresponding GCA 100C, such relies on proper connection between each of the individual connection interfaces 106 with corresponding elements of GCA 100C.

The amount of force required to properly connect a given connection interface 106 differs based on type, but as a representative example, specifications for an MMC-type connection interface 106 can suggest a suitable connection force is between 10-20 newtons (N) which converts to about 2.25 to about 4.5 pound force (lbf) in order to properly couple a single connection interface 106. Because GCA 100 gangs multiple connection interfaces, the individual connection forces sum. Thus, in order to properly connect a GCA 100 comprising 12 connection interfaces 106 to a corresponding CGA 100C may rely on application of about (12*4.5=)54 lbf, which can be exceedingly difficult to apply to existing GCA 100/100C.

In order to overcome these and other difficulties, the disclosed subject matter relates in some embodiments to a pincer apparatus that can couple and secure a connection between GCA 100 and corresponding GCA 100C. The disclosed pincer apparatus can, in some embodiments, leverage mechanical advantage to supply the target connection force based on supplied forces having a lower magnitude than the target connection force. The disclosed pincer apparatus can, in some embodiments, provide a more comfortable or convenient mechanism by which the supplied forces can be applied. Advantageously, the disclosed pincer apparatus can facilitate connections for GCA 100/100C that can be faster, more efficient, more reliable, and can do so in a manner that can potentially avoid injury to installation personnel or damage to equipment.

### Example Systems

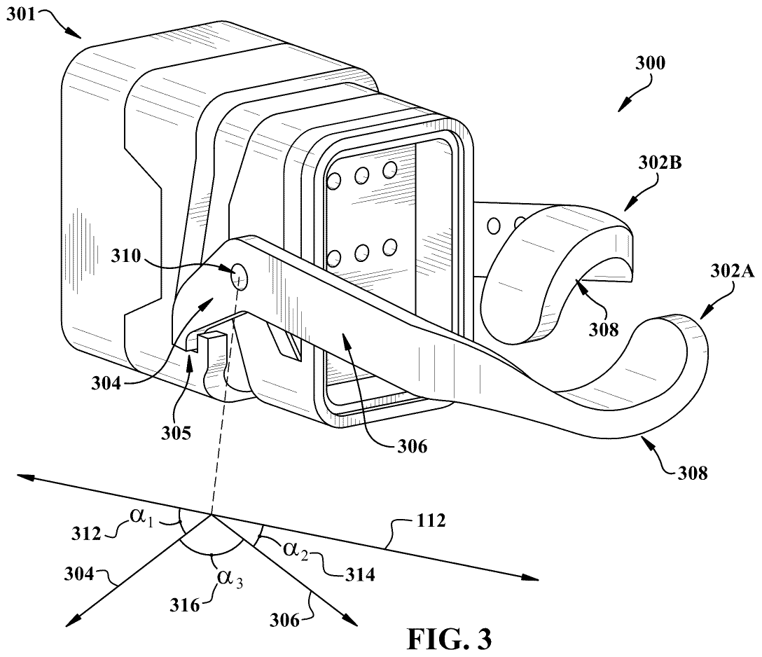

With reference to FIG. 3, an example isometric view of an example pincer apparatus 300 coupled to example combined housings 301 for ganged connectors in accordance with certain embodiments of this disclosure.

As illustrated, pincer apparatus 300 can comprise a first lever arm 302A and a second lever arm 302B, referred to collectively or individually as lever arm(s) 302. Pincer apparatus 300 can further comprise fulcrum element 310, which in this example is implemented as a rod or axel that extends through housing 301 in a direction parallel to lateral direction 114, and in which at least a portion of the rod or axel is exposed on each of two opposing lateral sides of housing 301. In a different embodiment, the rod or axel can extend in a direction parallel to lateral direction 116, in which case the two opposing lateral sides of housing 301 can be the top and bottom rather than the two sides as in the illustrated example.

Other implementations are envisioned. For example, fulcrum element 310 can be embodied as a band that surround housing 301, having joints at the two opposing sides with which to connect lever arms 302. In the latter case, the band can rely on frictional forces rather than an axel or rod to remain in place, and can be readily attached to existing housings 301, 102 for connector devices. Furthermore, a fulcrum can be implemented having a geometric retention or mechanical fasteners in other embodiments.

Regardless, lever arms 302 can couple to fulcrum element 310 on opposing sides of housing 301. One or both lever arms 302 can comprise hook section 304 that extends from fulcrum element 310 toward interface side 120 at a first angle 312 relative to axial direction 112. Hook section 304 can comprise a latch element 305 that can also be angled as depicted. Latch element 305 can be configured enter and be secured in a recess (e.g., recess 402A of FIG. 4) of corresponding GCA 100B.

Lever arms 302 can further comprise a lever section 306. Lever section 306 can extend from fulcrum element 310 toward conduit side 130 at a second angle 314. In some embodiments, the length of lever section 306 can be greater than the length of hook section 304 in order to provide mechanical advantage benefits. For reference, a third angle 316 representing an angle between hook section 304 and lever section 306, which can be determined as 180−(α₁+α₂). First angle 312 and second angle 314 and/or third angle 316 can be selected to ensure that application of a squeezing force (e.g., squeezing force 602 of FIG. 6) applied to lever arms 302 is translated into a connection force (e.g., connection force 606) in a direction substantially parallel to axial direction 112. Such can take into account the angled nature of latch element 305.

As depicted, lever arms 302 can further comprise a contoured section 308. Contoured section 308 can be specifically configured to contour to a shape of conduit 118 that extends from CGA 100 from conduit side 130. Hence, when applying the squeezing force during a coupling operation, contact, squeezing, or pinching of conduit 118 can be mitigated due to the contoured shape.

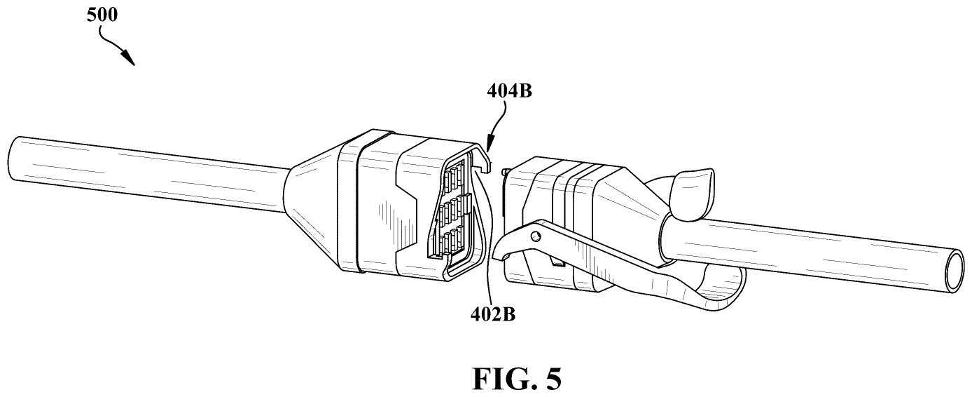

Referring now to FIGS. 4 and 5, FIG. 4 depicts a first example isometric view 400 of an example GCA 100 and the pincer apparatus 300 in an example first stage of coupling with a corresponding GCA 100C in accordance with certain embodiments of this disclosure. FIG. 5 depicts a second example isometric view 500 of the example GCA 100 and the pincer apparatus 300 in the example first stage of coupling with a corresponding GCA 100C in accordance with certain embodiments of this disclosure.

During the first stage, CGA 100 can be aligned with corresponding CGA 100C. Lever arms 302 can be in an “open” state as no squeezing force is being applied. As illustrated in connection with FIG. 4, corresponding CGA 100C can comprise recess 402A that can be formed at least partially by lip 404A. Recess 402A can be configured to receive at least latch element 305 of hook section 304 with respect to first lever arm 302A. As illustrated in connection with FIG. 5, corresponding CGA 100C can comprise recess 402B that can be formed at least partially by lip 404B. Recess 402B can be configured to receive at least latch element 305 of hook section 304 with respect to second lever arm 302B.

Hence, whereas recess 402A is proximal to the bottom portions of corresponding GCA 100C, recess 402B is proximal to the top portions of corresponding GCA 100C. It is understood that this convention can be reversed without departing from the techniques detailed herein. Likewise, while pincer apparatus 300 is illustrated here as being coupled to GCA 100, it is readily understood that pincer apparatus 300 could instead be coupled to corresponding GCA 100C and recesses 402 can be implemented on GCA 100 rather than corresponding GCA 100C, as shown in this example.

Turning now to FIG. 6, an example isometric view 600 is depicted illustrating an example GCA 100 and the pincer apparatus 300 in an example second stage of coupling with a corresponding GCA 100C in accordance with certain embodiments of this disclosure.

As shown, GCA 100 and corresponding GCA 100C have been aligned and brought into contact. Because pincer apparatus 300 was in the open state, latch element 305 clears lip 404 and enters recess 402. At the second stage, squeezing force 602 can be applied to pincer apparatus 300. Squeezing force 602 can comprise a first force 602A applied to first lever arm 302A in a first direction (e.g., lateral direction 116). Squeezing force 602 can further comprise a second force 602B applied to second lever arm 302B in a second direction that is substantially opposite the first direction.

In response to squeezing force 602, lever arms 302 undergo a rotational motion 604 about fulcrum element 310. The rotational motion 604 can cause a tightening force (e.g., connection force 606) to be applied by hook section 304 in a direction that is substantially parallel to axial direction 112. Connection force 606 can be specifically applied by latch element 305 to lip 404. Connection force 606 can be sufficient to secure GCA 100 to corresponding GCA 100C. In other words, connection force 606 can be sufficient to properly connect all connection elements 106 to associated elements of corresponding GCA 100C.

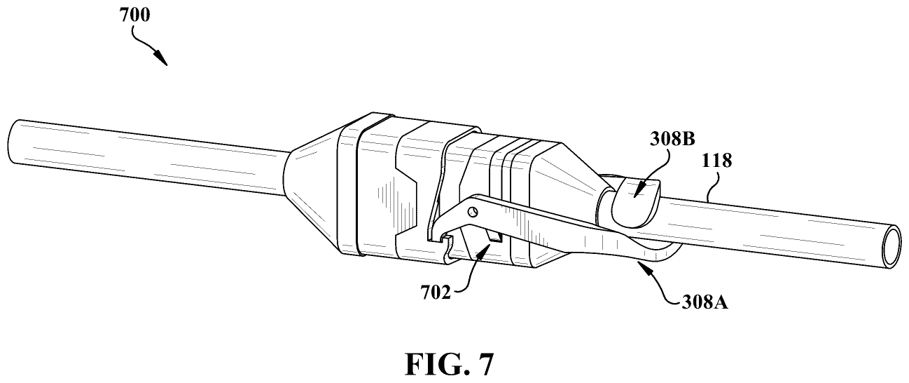

With reference now to FIG. 7, an example isometric view 700 is depicted illustrating an example GCA 100 and the pincer apparatus 300 in an example third stage of coupling with a corresponding GCA 100C in which a locking mechanism, e.g., a lock, engages in accordance with certain embodiments of this disclosure.

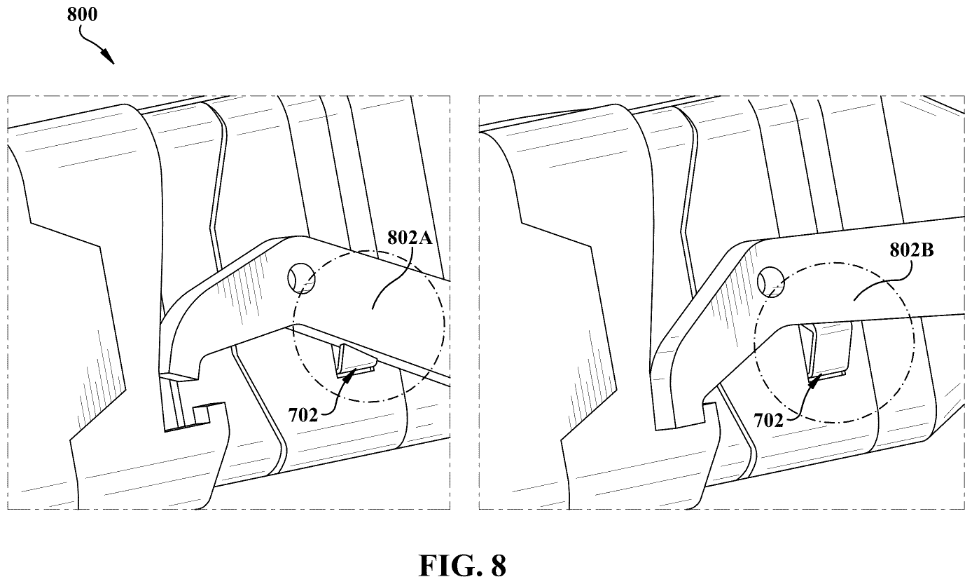

During the example third stage, e.g., during or after application of squeezing force 602 sufficient to couple GCA 100 to corresponding GCA 100C, locking element 702. In addition to locking element 702 engaging, which is further detailed in connection with FIG. 8, it can be observed how contoured sections 308A and 308B of respective lever arms 302A and 302B contour around conduit 118. It is to be understood that while locking element 702 is illustrated with respect to first lever arm 302A, another associated locking element 702 can be associated with second lever arm 302B.

Turning now to FIG. 8, an example isometric view 800 is depicted illustrating the locking element 702 with respect to two different states 802 of the lever arm 302 in accordance with certain embodiments of this disclosure. As detailed in FIG. 6, application of squeezing force 602 can cause lever arms 302 to exhibit rotational motion 604 about fulcrum element 310.

When lever arm 302 is in a first state 802A corresponding to an open state and/or prior to application of squeezing force 602, locking element 702 does not clear the lever arm 302 and thus remains compressed. However, during or after application of squeezing force 602, as lever arm 302 rotates, locking element 702 can clear lever arm 302 and move into an extended position, e.g., due to an internal spring. Once engaged, lock element 702 can prevent lever arm 302 from rotating in a manner to disengage. In some embodiments, lock element 702 can be disengaged by pressing (e.g., against the force applied by the internal spring) in order to allow disengaging rotation by lever arm 302.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In addition, the term “or” is intended to mean an inclusive “or” rather than an exclusive “or,” akin to the meaning of “and/or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

What has been described above includes examples of systems and methods illustrative of the disclosed subject matter. It is, of course, not possible to describe every combination of components or methodologies here. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

### Aspects

The disclosed subject matter can comprise numerous aspects or embodiments. It is appreciated that aspects described here or above can generally be combined together with any other suitable aspect or combination(s) of aspects, even including combinations not specifically indicated by the below example aspects.

Aspect 1: A connector apparatus, comprising: a housing comprising a group of connection interfaces situated on an interface side of the connector apparatus that is opposite, relative to an axial direction, to a conduit side of the connector apparatus, wherein first members of the group of connection interfaces are respectively configured to couple to respective second members of a corresponding group of connection interfaces of a corresponding connector apparatus; a fulcrum element that extends in a lateral direction through the housing and is exposed at opposing lateral sides of the housing; a first lever arm that is coupled to a first portion of the fulcrum element that is exposed at a first side of the housing; and a second lever arm that is coupled to a second portion of the fulcrum element that is exposed at a second side of the housing, wherein the first lever arm and the second lever arm each comprise: a hook section that extends from the fulcrum element toward the interface side at a first angle relative to the axial direction and that comprises a latch element configured to be secured in a recess of the corresponding connector apparatus; and a lever section that extends from the fulcrum element toward the conduit side at a second angle relative to the axial direction, wherein, in response to a squeezing force comprising a first force applied to the first lever arm in a first direction and a second force applied to the second lever arm in a second direction that is substantially opposite the first direction, a tightening force is applied by the hook section in the axial direction that secures the connector apparatus to the corresponding connector apparatus.

Aspect 2: The connector apparatus of aspect 1, wherein the group of connection interfaces conforms to a fiber optic connector standard.

Aspect 3: The connector apparatus of aspect 1, wherein the group of connection interfaces has a form factor compliant with at least one of: a miniature multi-channel connector, a multi-fiber push on connector, or a multi-fiber termination push-on connector.

Aspect 4: The connector apparatus of aspect 1, wherein the lever section has a greater length than the hook section, causing a mechanical increase for the squeezing force with respect to the tightening force.

Aspect 5: The connector apparatus of aspect 1, wherein at least one of the first lever arm or the second lever arm comprises a contoured section that is contoured to a shape of a conduit that extends from the conduit side.

Aspect 6: The connector apparatus of aspect 1, further comprising a locking element that locks at least one of the first lever arm or the second lever arm from being moveable as a result of the connector apparatus being secured to the corresponding connector apparatus.

Aspect 7: The connector apparatus of aspect 6, wherein the locking element engages in response to at least one of first motion of the first lever arm in the first direction or second motion of the second lever arm in the second direction that result from the squeezing force that is sufficient to secure the connector apparatus to the corresponding connector apparatus.

Aspect 8: The connector apparatus of aspect 6, wherein the locking element comprises a spring release that, in response to a release force applied to the locking element, releases the at least one of the first lever arm or the second lever arm, enabling at least one corresponding hook portion of the at least one of the first lever arm or the second lever arm to exit at least one corresponding recess of the corresponding connector apparatus, resulting in the connector apparatus decoupling from the corresponding connector apparatus.

Aspect 9: An apparatus, comprising: a fulcrum element that extends in a lateral direction through a housing of a connector device that is configured to couple to a corresponding connector device in response to a connection force applied in an axial direction, wherein the fulcrum element is exposed at opposing lateral sides of the housing; a first lever arm that is coupled to a first portion of the fulcrum element that is exposed at a first side of the housing; and a second lever arm that is coupled to a second portion of the fulcrum element that is exposed at a second side of the housing, wherein the first lever arm comprises: a first hook section that extends from the fulcrum element toward an interface side of the connector device at a first angle relative to the axial direction and comprises a first latch element configured to be secured in a first recess of the corresponding connector apparatus; and a first lever section that extends from the fulcrum element toward a conduit side of the connector device at a second angle relative to the axial direction, wherein the second lever arm comprises: a second hook section that extends from the fulcrum element toward an interface side of the connector device at a third angle relative to the axial direction and comprises a second latch element configured to be secured in a second recess of the corresponding connector apparatus; and a second lever section that extends from the fulcrum element toward the conduit side at a fourth angle relative to the axial direction, wherein, in response to a squeezing force comprising a first force applied to the first lever arm in a first direction and a second force applied to the second lever arm in a second direction that is substantially opposite the first direction, the connection force in the axial direction is applied by the first hook section and the second hook section.

Aspect 10: The apparatus of aspect 9, wherein the fulcrum element is a removable rod configured to be inserted through lateral openings in the housing.

Aspect 11: The apparatus of aspect 9, wherein at least one of the first lever section or the second lever section comprises a textured grip surface to facilitate application of the squeezing force.

Aspect 12: The apparatus of aspect 9, wherein the first latch element is integrally formed with the first hook section, and wherein the second latch element is integrally formed with the second hook section.

Aspect 13: The apparatus of aspect 9, wherein the first hook section is biased by a first spring element toward the axial direction, and wherein the second hook section is biased by a second spring element toward the axial direction.

Aspect 14: The apparatus of aspect 9, wherein the housing comprises alignment guides configured to align the connector device at the interface side during coupling to the corresponding connector apparatus.

Aspect 15: The apparatus of aspect 9, wherein the connector device comprises, at the interface side, a group of fiber optic ferrules mounted in a spring-loaded nest.

Aspect 16: A pincer apparatus, comprising: a fulcrum configured to be removably coupled to a housing of a connector device, wherein the connector device comprises a group of connection interfaces configured to couple to a corresponding group of connection interfaces of a corresponding connector device; a first lever arm coupled to a first portion of the fulcrum and a second lever arm coupled to a second portion of the fulcrum, wherein the first lever arm and the second lever arm comprise: respective hook sections configured to extend toward an interface side of the connector device and comprising respective latches configured to engage with respective recesses of the corresponding connector device; and respective lever sections configured to extend toward a conduit side of the connector device and to receive a squeezing force, wherein, in response to application of the squeezing force in a lateral direction, a connection force results in an axial direction to secure the connector device to the corresponding connector device.

Aspect 17: The pincer apparatus of aspect 16, wherein the respective fulcrums comprise respective axles configured to be inserted through respective pre-existing lateral channels of the housing.

Aspect 18: The pincer apparatus of aspect 16, wherein the respective fulcrums comprise respective flexible bands that surround the housing of the connector device.

Aspect 19: The pincer apparatus of aspect 16, wherein the respective lever sections comprise respective contoured portions configured to contour around respective conduits extending from the conduit side of the connector device.

Aspect 20: The pincer apparatus of aspect 16, further comprising a lock configured to retain at least one of the first lever arm or the second lever arm in a closed position after coupling the connector device to the corresponding connector device.

What is claimed is:

1. A connector apparatus, comprising:
a housing comprising a group of connection interfaces situated on an interface side of the connector apparatus that is opposite, relative to an axial direction, to a conduit side of the connector apparatus, wherein first members of the group of connection interfaces are respectively configured to couple to respective second members of a corresponding group of connection interfaces of a corresponding connector apparatus;
a fulcrum element that extends in a lateral direction through the housing and is exposed at opposing lateral sides of the housing;
a first lever arm that is coupled to a first portion of the fulcrum element that is exposed at a first side of the housing; and
a second lever arm that is coupled to a second portion of the fulcrum element that is exposed at a second side of the housing,
wherein the first lever arm and the second lever arm each comprise:
a hook section that extends from the fulcrum element toward the interface side at a first angle relative to the axial direction and that comprises a latch element configured to be secured in a recess of the corresponding connector apparatus; and
a lever section that extends from the fulcrum element toward the conduit side at a second angle relative to the axial direction,
wherein, in response to a squeezing force comprising a first force applied to the first lever arm in a first direction and a second force applied to the second lever arm in a second direction that is substantially opposite the first direction, a tightening force is applied by the hook section in the axial direction that secures the connector apparatus to the corresponding connector apparatus.

2. The connector apparatus of claim 1, wherein the group of connection interfaces conforms to a fiber optic connector standard.

3. The connector apparatus of claim 1, wherein the group of connection interfaces has a form factor compliant with at least one of: a miniature multi-channel connector, a multi-fiber push on connector, or a multi-fiber termination push-on connector.

4. The connector apparatus of claim 1, wherein the lever section has a greater length than the hook section, causing a mechanical increase for the squeezing force with respect to the tightening force.

5. The connector apparatus of claim 1, wherein at least one of the first lever arm or the second lever arm comprises a contoured section that is contoured to a shape of a conduit that extends from the connector device from the conduit side.

6. The connector apparatus of claim 1, further comprising a locking element that locks at least one of the first lever arm or the second lever arm from being moveable as a result of the connector apparatus being secured to the corresponding connector apparatus.

7. The connector apparatus of claim 6, wherein the locking element engages in response to at least one of first motion of the first lever arm in the first direction or second motion of the second lever arm in the second direction that result from the squeezing force that is sufficient to secure the connector apparatus to the corresponding connector apparatus.

8. The connector apparatus of claim 6, wherein the locking element comprises a spring release that, in response to a release force applied to the locking element, releases the at least one of the first lever arm or the second lever arm, enabling at least one corresponding hook portion of the at least one of the first lever arm or the second lever arm to exit at least one corresponding recess of the at least one of the first lever arm or the second lever arm, resulting in the connector apparatus decoupling from the corresponding connector apparatus.

9. An apparatus, comprising:
a fulcrum element that extends in a lateral direction through a housing of a connector device that is configured to couple to a corresponding connector device in response to a connection force applied in an axial direction, wherein the fulcrum element is exposed at opposing lateral sides of the housing;
a first lever arm that is coupled to a first portion of the fulcrum element that is exposed at a first side of the housing; and
a second lever arm that is coupled to a second portion of the fulcrum element that is exposed at a second side of the housing,
wherein the first lever arm comprises:
a first hook section that extends from the fulcrum element toward an interface side of the connector device at a first angle relative to the axial direction and comprises a first latch element configured to be secured in a first recess of the corresponding connector apparatus; and
a first lever section that extends from the fulcrum element toward a conduit side of the connector device at a second angle relative to the axial direction,
wherein the second lever arm comprises:
a second hook section that extends from the fulcrum element toward an interface side of the connector device at a third angle relative to the axial direction and comprises a second latch element configured to be secured in a second recess of the corresponding connector apparatus; and
a second lever section that extends from the fulcrum element toward a conduit side of the connector device at a fourth angle relative to the axial direction,
wherein, in response to a squeezing force comprising a first force applied to the first lever arm in a first direction and a second force applied to the second lever arm in a second direction that is substantially opposite the first direction, the connection force in the axial direction is applied by the first hook section and the second hook section.

10. The apparatus of claim 9, wherein the fulcrum element is a removable rod configured to be inserted through lateral openings in the housing.

11. The apparatus of claim 9, wherein at least one of the first lever section or the second lever section of at least one of the first lever arm or the second lever arm comprises a textured grip surface to facilitate application of the squeezing force.

12. The apparatus of claim 9, wherein the first latch element is integrally formed with the first hook section, and wherein the second latch element is integrally formed with the second hook section.

13. The apparatus of claim 9, wherein the first hook section is biased by a first spring element toward the axial direction, and wherein the second hook section is biased by a second spring element toward the axial direction.

14. The apparatus of claim 9, wherein the housing comprises alignment guides configured to align the connector device at the interface side during coupling to the corresponding connector apparatus.

15. The apparatus of claim 9, wherein the connector device comprises, at the interface side, a group of fiber optic ferrules mounted in a spring-loaded nest.

16. A pincer apparatus, comprising:
a fulcrum configured to be removably coupled to a housing of a connector device, wherein the connector device comprises a group of connection interfaces configured to couple to a corresponding group of connection interfaces of a corresponding connector device;
a first lever arm coupled to a first portion of the fulcrum and a second lever arm coupled to a second portion of the fulcrum, wherein the first lever arm and the second lever arm comprise:
respective hook sections configured to extend toward an interface side of the connector device and comprising respective latches configured to engage with respective recesses of the corresponding connector device; and
respective lever sections configured to extend toward a conduit side of the connector device and to receive a squeezing force,
wherein, in response to application of the squeezing force in a lateral direction, a connection force results in an axial direction to secure the connector device to the corresponding connector device.

17. The pincer apparatus of claim 16, wherein the respective fulcrums comprise respective axles configured to be inserted through respective pre-existing lateral channels of the housing.

18. The pincer apparatus of claim 16, wherein the respective fulcrums comprise respective flexible bands that surround the housing of the connector device.

19. The pincer apparatus of claim 16, wherein the respective lever sections comprise respective contoured portions configured to contour around respective conduits extending from the conduit side of the connector device.

20. The pincer apparatus of claim 16, further comprising a lock configured to retain at least one of the first lever arm or the second lever arm in a closed position after coupling the connector device to the corresponding connector device.
